(19) United States
(12) Patent Application Publication
(10) Pub. No.: US 2005/0207322 A1
(43) Pub. Date: Sep. 22, 2005

(54) Phase change optical disk

(76) Inventor: Hon-Lun Chen, Taipei Hsien (TW)

Correspondence Address: BIRCH STEWART KOLASCH & BIRCH, PO BOX 747, FALLS CHURCH, VA, 22040-0747, US

(21) Appl. No.: 10/802,740

(22) Filed: Mar. 18, 2004

(51) Int. Cl. G11B 7/24

(52) U.S. Cl. 369/275.2

(57) ABSTRACT

A phase change optical disk includes a substrate, a first dielectric layer, a second dielectric layer, a third dielectric layer, a recording layer, a fourth dielectric layer and a reflecting layer. In this case, the first dielectric layer is formed on the substrate. The second dielectric layer is formed on the first dielectric layer. The refractive index of the second dielectric layer is greater than the refractive index of the first dielectric layer. The third dielectric layer is formed on the second dielectric layer. The refractive index of the third dielectric layer is small than the refractive index of the second dielectric layer. The recording layer is formed on the third dielectric layer, and the fourth dielectric layer is formed on the recording layer. The reflecting layer is formed on the fourth dielectric layer.

### BACKGROUND OF THE INVENTION

1. Field of Invention

The invention relates to an optical disk and, in particular, to a phase change optical disk, which has a multi dielectric layers structure for preventing the cross-erase and increasing the reflection difference.

2. Related Art

In the past, when the rewritable optical disk is invented, two systems of the rewritable optical disk, including the magneto-optical disk (MO) and the phase change optical disk, are developed. Accompanying with the progress of technology and the change of market, the phase change recording medium is now in an advantaged situation and includes CD-RW, DVD−RW, DVD+RW, and DVD-RAM.

As shown in FIG. 1, a conventional phase change optical disk 1 includes a substrate 11, and a first dielectric layer 12, a recording layer 13, a second dielectric layer 14 and a reflecting layer 15, which are formed on the substrate 11 in sequence.

The phase change optical disk 1 is irradiated with laser light. In detail, a laser beam passes through the substrate 11, the first dielectric layer 12, and the recording layer. Then, the material of the recording layer 13 is transformed between a crystalline phase and an amorphous phase according to the energy of the laser beam. Alternatively, the laser beam could be reflected by the reflecting layer 15, and the pick up head could read in the recorded data, such as the binary of 0 and 1, according to the high reflectivity (R_{c}) of the crystalline phase and the low reflectivity (Rₐ) of the amorphous phase. When writing data into the phase change optical disk, a high power laser short pulse is employed to irradiate the recording layer 13 to melt the irradiated portion. The melted portion of the recording layer 13 is then cooled down rapidly and is transformed into the amorphous phase structure. When erasing the data in the phase change optical disk, a low power laser pulse is employed to irradiate the recording layer 13 to anneal the irradiated portion. The annealed portion of the recording layer 13 is then transformed into the crystalline phase structure.

In the conventional phase change optical disk, the light absorption (Aₐ) in the amorphous state is usually greater than the light absorption (Ac) in the crystalline state. Recently, the blue light laser beam having the wavelength less than 450 nm is employed to replace near infrared light or red light laser beam, and the interval between the tracks is decreased so as to the recording density of the optical disk. However, as the interval between the tracks is decreased, the laser beam for recording data located in one track may also heat an adjacent track. The data recorded at the adjacent track may thus be erased, which is so-called the cross-erase. When the ratio of the light absorption Aₐ to the light absorption A_{c} increases, the cross-erase could be reduced. Therefore, if the recording density increases, the ratio of the light absorption Aₐ to the light absorption A_{c} should be increased to maximum.

In addition, as shown in FIG. 2, when the light source of shorter wavelength is used to irradiate the conventional phase change optical disk, the reflectivity difference between the crystalline phase and the amorphous phase of the recording layer may be decreased as shorter as the wavelength. If the reflectivity difference between the crystalline phase and the amorphous phase is too small, the pick up head could not determine the recorded data marks correctly.

However, it is difficult to make the light absorption (Aₐ) in the amorphous state smaller than the light absorption (A_{c}) in the crystalline state, and to keep the reflectivity difference (R_{c-a}) between the crystalline phase and the amorphous phase sufficient enough so as to determine the recorded data marks correctly.

It is therefore a subjective of the invention to provide a phase change optical disk for preventing the cross-erase and increasing the reflectivity difference.

### SUMMARY OF THE INVENTION

In view of the forgoing, the invention is to provide a phase change optical disk having multi dielectric layers, which can prevent the cross-erase and increase the reflectivity difference.

To achieve the above, the phase change optical disk of the invention includes a substrate, a first dielectric layer, a second dielectric layer, a third dielectric layer, a recording layer, a fourth dielectric layer and a reflecting layer. In the invention, the first dielectric layer is formed on the substrate. The second dielectric layer is formed on the first dielectric layer. The refractive index (n2) of the second dielectric layer is greater than the refractive index (n1) of the first dielectric layer. The third dielectric layer is formed on the second dielectric layer, and the refractive index (n3) of the third dielectric layer is less than the refractive index (n2) of the second dielectric layer. The recording layer is formed on the third dielectric layer, and the fourth dielectric layer is formed on the recording layer. The reflecting layer is formed on the fourth dielectric layer.

Since the phase change optical disk of the invention has multi dielectric layers, the cross-erase can be prevented. Comparison with the prior art, the phase change optical disk of the invention provides the first dielectric layer, the second dielectric layer, and the third dielectric layer in sequence between the substrate and the recording layer. Wherein, the refractive index (n2) of the second dielectric layer is greater than the refractive index (n1) of the first dielectric layer, and the refractive index (n3) of the third dielectric layer is less than the refractive index (n2) of the second dielectric layer. Thus, the phase change optical disk of the invention can increase the ratio of the light absorptions (A_{c}/Aₐ) so as to reduce the cross-erase. In addition, the reflectivity difference between the crystalline phase and the amorphous phase could be sufficient when using short wavelength light source, so that the correctness of determining the recorded data marks can be improved.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing a conventional phase change optical disk;

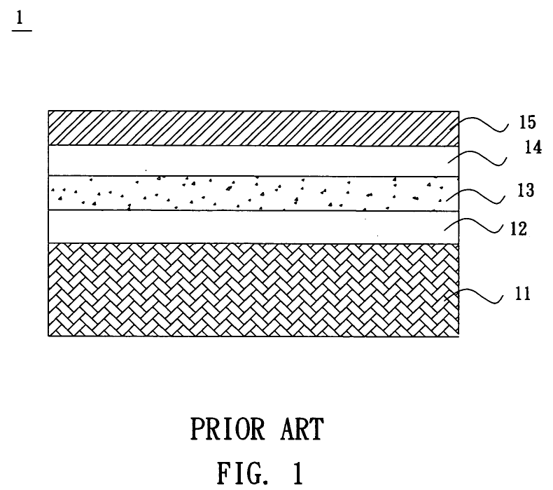

FIG. 2 is a schematic view showing a table representing the reflectivity of the recording layer in the crystalline state and amorphous state; and

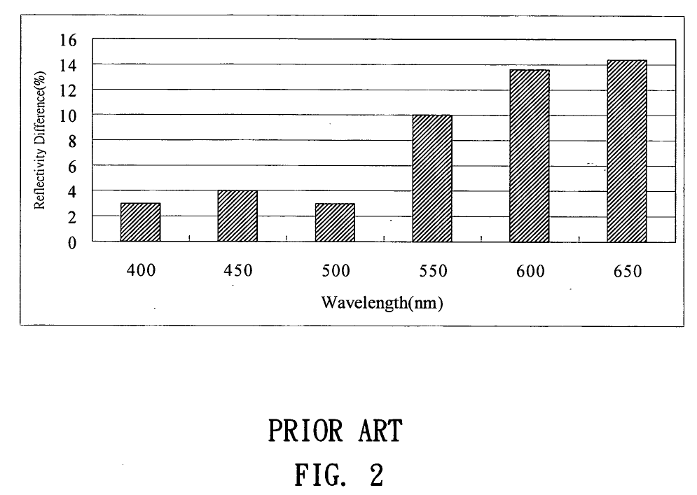

FIG. 3 is a schematic view showing a phase change optical disk according to a preferred embodiment of the invention.

### DETAILED DESCRIPTION OF THE INVENTION

The phase change optical disk according to the embodiments of the invention will be described below with reference to relevant drawings, wherein the same elements are referred with the same reference numbers.

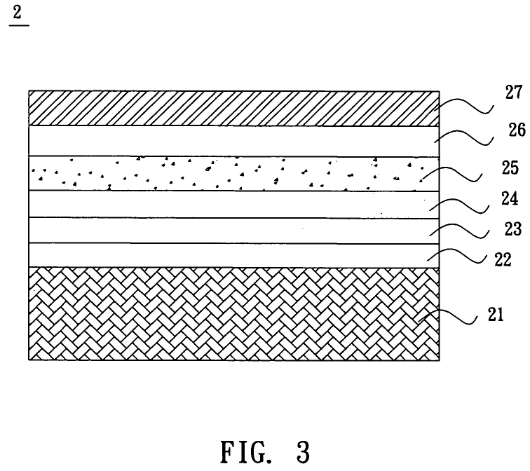

With reference to FIG. 3, a phase change optical disk 2 according to the embodiment of the invention includes a substrate 21, a first dielectric layer 22, a second dielectric layer 23, a third dielectric layer 24, a recording layer 25, a fourth dielectric layer 26, and a reflecting layer 27.

The phase change optical disk 2 could be a recording medium such as a CD-RW, DVD−RW, DVD+RW, or DVD-RAM.

The material of the substrate 21 is usually polycarbonate (PC) and polymethylmethacrylate (PMMA). These materials have the characteristic of cheap and low cost for ejection molding.

The first dielectric layer 22, the second dielectric layer 23, and the second dielectric layer 24 utilize the light interference effect to adjust the reflectivity and absorption ratio of the optical disk. Thus, the recording layer 25 can be prevented from evaporation, and thermal damage of the substrate 21 is avoided. The first dielectric layer 22 is disposed on the substrate 21, the second dielectric layer 23 is disposed on the first dielectric layer 22, and the third dielectric layer 24 is disposed on the second dielectric layer 23.

In the embodiment, the first dielectric layer 22 is made of aluminum oxide (Al₂O₃) having the thickness of 30 nm and the refracting index (n1) of 1.6. The second dielectric layer 23 is made of zinc sulfur-silicon dioxide (ZnS—SiO₂) having the thickness of 100 nm and the refracting index (n2) of 2.05. The third dielectric layer 24 is made of aluminum oxide (Al₂O₃) having the thickness of 15 nm and the refracting index (n3) of 1.6. Therefore, the refractive index (n2) of the second dielectric layer 23 is greater than the refractive index (n1) of the first dielectric layer 22, and the refractive index (n3) of the third dielectric layer 24 is less than the refractive index (n2) of the second dielectric layer 23. It is to be noted that the first dielectric layer 22 and the third dielectric layer 24 are not constricted to the aluminum oxide (Al₂O₃), and the second dielectric layer 23 is not constricted to the zinc sulfur-silicon dioxide (ZnS—SiO₂). Any dielectric material that can make the index n2 greater than the index n1 and the index n2 also greater than the index n3 is suitable for the dielectric layers. For example, the dielectric material of the first dielectric layer 22 or the third dielectric layer 24 could be silicon dioxide or silicon nitride, and the dielectric material of the second dielectric layer 23 could be zinc sulfur.

The recording layer 25 is disposed on the third dielectric layer 24 and is made of the compound mainly consisting of germanium (Ge), stibium (Sb), and tellurium (Te). The phase of the point of the recording layer 25, which is irradiated by the laser beam, can be reversibly changed between crystalline state and amorphous state according to the power of the laser beam: In the present embodiment, the recording layer 25 is made of Ge₂Sb₂Te₅ having the thickness of 9.5 nm.

The fourth dielectric layer 26 is disposed on the recording layer 25. In this embodiment, the fourth dielectric layer 26 is made of zinc sulfur-silicon dioxide (ZnS—SiO₂) having the thickness of 38 nm.

The reflecting layer 27 is consisting of the alloy material possessing of superior reflectivity and high heat conductivity. The alloy material is at least one selected from the group consisting of gold, aluminum, titan, copper, chromium, and the alloy thereof. The reflecting layer 27 can reflect the incident light beam generated by a laser light source, and dissipate the heat generated at the recording layer 25. The reflecting layer 27 is disposed on the fourth dielectric layer 26. In the embodiment, the reflecting layer 27 is made of aluminum alloy having the thickness of 60 nm.

The phase change optical disk of the invention may further include a plurality of interface layers, comprising a first interface layer disposed between the third dielectric layer 24 and the recording layer 25, and a second interface layer disposed between the recording layer 25 and the fourth dielectric layer 26. The interface layers are capable of promoting the crystallization of the recording layer 25, increasing the erasing property, and preventing the atom diffusion between the recording layer 25 and the dielectric layers so as to enhance the durability of the phase change optical disk. The interface layers are usually made of the compound containing nitrogen. In the present embodiment, the first and second interface layers are made of germanium nitride (GeN) having the thickness of 5 nm.

Furthermore, the phase change optical disk of the embodiment is suitable for the optical disk driver with short wavelength light source or long wavelength light source. The short wavelength light source is, for example, a blue light laser diode, and the long wavelength light source is, for example, a red light laser diode.

In the current embodiment, the light absorption (A_{c}) in the crystalline state of the recording layer is 72%, and the light absorption (Aₐ) in the amorphous state is 63%, resulting in the ratio of A_{c}/Aₐ is greater than 1. Thus, the cross-erase issue may be reduced. Furthermore, when utilizing the blue light laser diode having the wavelength of 400 nm, the phase change optical disk of the invention has the reflectivity difference (R_{c-a}) between the crystalline phase and the amorphous phase equal to 14%. This is obviously differ from the prior art, which teaches that when the light source of shorter wavelength is used to irradiate the conventional phase change optical disk, the reflectivity difference between the crystalline phase and the amorphous phase of the recording layer is decreased as shorter as the wavelength.

To sum up, the phase change optical disk of the invention has multi dielectric layers, so as to prevent the cross-erase and increase the reflectivity difference. Comparison with the prior art, the phase change optical disk of the invention provides the first dielectric layer, the second dielectric layer, and the third dielectric layer in sequence between the substrate and the recording layer. Wherein, the refractive index (n2) of the second dielectric layer is greater than the refractive index (n1) of the first dielectric layer, and the refractive index (n3) of the third dielectric layer is less than the refractive index (n2) of the second dielectric layer. Thus, the phase change optical disk of the invention can increase the ratio of the light absorption in the amorphous state to the light absorption in the crystalline state (Aₐ/A_{c}) so as to reduce the cross-erase. In addition, the reflectivity difference between the crystalline phase and the amorphous phase could be sufficient when using short wavelength light source, so that the correctness of determining the recorded data marks can be improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A phase change optical disk, comprising:
a substrate;
a first dielectric layer, which is formed on the substrate;
a second dielectric layer, which is formed on the first dielectric layer, wherein the refractive index n2 of the second dielectric layer is greater than the refractive index n1 of the first dielectric layer;
a third dielectric layer, which is formed on the second dielectric layer, wherein the refractive index n3 of the third dielectric layer is less than the refractive index n2 of the second dielectric layer;
a recording layer, which is formed on the third dielectric layer;
a fourth dielectric layer, which is formed on the recording layer; and
a reflecting layer, which is formed on the fourth dielectric layer.

2. The phase change optical disk of claim 1, which is suitable for an optical disk driver with a short wavelength light source.

3. The phase change optical disk of claim 2, wherein the short wavelength light source is a blue light laser diode.

4. The phase change optical disk of claim 1, which is suitable for an optical disk driver with a long wavelength light source.

5. The phase change optical disk of claim 4, wherein the long wavelength light source is a red light laser diode.

6. The phase change optical disk of claim 1, wherein the first dielectric layer is made of silicon dioxide (SiO₂).

7. The phase change optical disk of claim 1, wherein the first dielectric layer is made of aluminum oxide (Al₂O₃).

8. The phase change optical disk of claim 1, wherein the second dielectric layer is made of zinc sulfur-silicon dioxide (ZnS—SiO₂).

9. The phase change optical disk of claim 6, wherein the third dielectric layer is made of silicon dioxide.

10. The phase change optical disk of claim 7, wherein the third dielectric layer is made of aluminum oxide.

11. The phase change optical disk of claim 1, wherein the material of the reflecting layer is selected from the group consisting of gold, aluminum, titan, copper, chromium, and the alloy thereof.
